(19) United States
(12) Patent Application Publication
(10) Pub. No.: US 2026/0276698 A1
(43) Pub. Date: Sep. 17, 2026

(54) ELECTROMIGRATION EVALUATION METHODOLOGY WITH CONSIDERATION OF HEAT DISSIPATING STRUCTURE EFFECTS

(71) Applicant: Taiwan Semiconductor Manufacturing Company, Ltd., Hsinchu (TW)

(72) Inventors: Wei-Ming Chen, Hsinchu (TW); Wen-Che Liao, Hsinchu (TW); Ming-Hong Hsieh, Hsinchu (TW); Chun-Wei Chang, Hsinchu (TW); Hsien Yu Tseng, Hsinchu (TW)

(73) Assignee: Taiwan Semiconductor Manufacturing Company, Ltd., Hsinchu (TW)

(21) Appl. No.: 19/080,626

(22) Filed: Mar. 14, 2025

(51) Int. Cl. G01R 31/28

(52) U.S. Cl. CPC G01R 31/2858; G01R 31/2875; G01R 31/2877

(57) ABSTRACT

A temperature derating methodology in thermal-aware electromigration (EM) analysis may comprise identifying a heat sensitive structure, a first heat generating structure, and a first heat dissipating structure. The temperature derating methodology comprises adjustments of an evaluation temperature for the heat sensitive structure by adjusting an operation temperature of the first heat generating structure and calculating a temperature increase for the heat sensitive structure.

### BACKGROUND

Current passing through conductive lines induces electromigration (EM), i.e., the movement of the metal atoms resulting from momentum transfer between the electrons passing through the conductive lines and the metal atoms comprising the conductive lines. Over time, EM causes the formation of hillocks (accumulation of excess metal) and/or voids (depletion of initial metal) in the wire which, in turn, tends to result in short circuits (hillocks) or open circuits (voids).

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic view of a process of electromigration (EM) within interconnected metal wires in accordance with some embodiments.

FIG. 2 illustrates an example system that is suitable for evaluating a heat sensitive structure in accordance with some embodiments.

FIG. 3 is a schematic view of an EM tool useful in the operation of a thermal aware EM analysis in accordance with some embodiments.

FIG. 4 is a plan view of an active region (AR) in accordance with some embodiments.

FIG. 5 is a flow chart of a method for evaluating a heat sensitive structure in accordance with some embodiments.

FIG. 6 is a plan view of an active region (AR) with and without backside via (VB) effect in accordance with some embodiments.

FIG. 7 is a plan view of an active region (AR) with and without backside via (VB) effect in accordance with some embodiments.

FIG. 8 is a plan view of an active region (AR) with and without backside via (VB) effect in accordance with some embodiments.

FIG. 9 is a plan view of an active region (AR) with backside via (VB) effect in accordance with some embodiments.

FIG. 10 is a flow chart of a method for evaluating a heat sensitive structure in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Semiconductor devices tend to increase in temperature during use as a result of self-heating effects (SHE). These SHE limit both the performance capability and the operational lifetime of the affected semiconductor devices. For example, self-heating effects in semiconductor devices such as fin field effect transistors (FinFETs) will tend to reduce device performance and reliability.

Accordingly, some FinFET integrated circuit designs utilize the conductive lines and interconnecting vias as heat dissipation conduits for controlling the temperature of the active structures. This technique for dissipating heat; however, increases the operating temperature of the conductive lines. The heating from other active elements, when coupled with inherent current/resistance (IR) heating (also referred to as ohmic or joule heating) of conductive lines, increases the risk of accelerated EM-related failures. Device designers seek to address the risk of increased EM resulting from SHE in the conductive lines to some degree by modifying the integrated circuit design and/or operational parameters, but such design compensations tend to reduce the density, reduce the performance, and/or increase the size of the resulting semiconductor device.

In some instances, a FinFET semiconductor device includes a substrate in which is formed an active region in which a source and drain are formed, a guard ring, a plurality of conductive line layers separated by layers of interlayer dielectric (ILD) material(s), and vias formed through the ILD materials to establish electrical connections to and between the conductive line layers. Depending on the particular integrated circuit design, heat generated within the active regions of the semiconductor device will reach portions of the conductive line layers that are within the active region impact range and, to some extent, through the vias connecting the conductive lines to the active region.

In a super power rail (SPR) process, a thin substrate results in weak heat dissipation, which becomes a significant concern, particularly in high-performance computing (HPC) applications. The highly switching nanosheet devices exacerbate the problem by inducing self-heating effects that elevate the temperature of surrounding metal wires, further deteriorating the electromigration (EM) condition. For instance, a 10° C. temperature increase can degrade the EM limit by up to 50%. A backside via (VB) is identified as effective heat sinks, mitigating the heat problem in the SPR process by reducing temperature by approximately 5%, as demonstrated through simulations under identical power conditions. However, the current thermal-aware EM analysis flows do not account for the VB effect. This disclosure seeks to address this limitation, providing a robust solution to incorporate VB effects into EM analysis and safeguard the methodology.

The present disclosure provides various embodiments of a method for evaluating a heat sensitive structure. The method comprises identifying a heat sensitive structure in an integrated circuit design layout, the heat sensitive structure having a nominal temperature Tₙₒₘ. The method comprises identifying a first heat generating structure within a thermal coupling distance of the heat sensitive structure. The method comprises identifying a first heat dissipating structure extending through a substrate on which the first heat generating structure is formed. The method comprises adjusting an operating temperature Tₒₚₕ₁ of the first heat generating structure as an adjusted operating temperature Tₒₚₕ₁′. The method comprises calculating a temperature increase ΔTₕ₁ for the heat sensitive structure induced by thermal coupling to the first heat generating structure at the adjusted operating temperature Tₒₚₕ₁′. The method comprises evaluating the heat sensitive structure at an evaluation temperature T_{E}=Tₙₒₘ+ΔTₕ₁. This disclosure relates to a methodology for modeling the backside via (VB) effect in thermal-aware EM analysis.

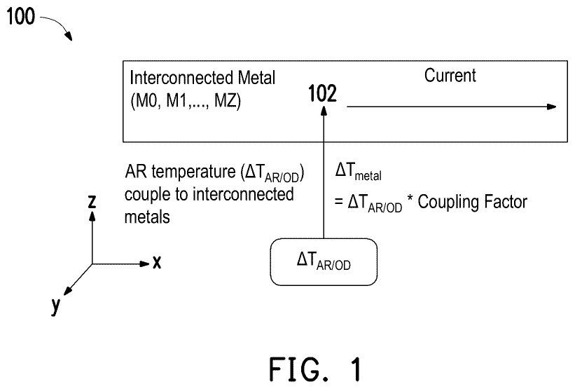

FIG. 1 is a schematic view of a process of electromigration (EM) within interconnected metal wires in accordance with some embodiments. As in FIG. 1, conductive line segment 100 includes a plurality of interconnected metal 102, selected from a group of metals including, e.g., aluminum (Al), copper (Cu), titanium (Ti), tantalum (Ta), tungsten (W), platinum (Pt), cobalt (Co) and, in some embodiments, one or more alloying metals or other elements including nickel (Ni), nitrogen (N), and silicon (Si), that have been patterned to form a conductive path for the electrons moving between the cathode and the anode.

Electromigration (EM) limits are significantly impacted by temperature variations. For instance, assuming an initial EM limit (EMₗᵢₘᵢₜ) of 1 mA at 105° C., a temperature increase of 10° C. (ΔT_{AR/OD}=10° C.) with a coupling factor of 1 results in a substantial reduction of the EM limit. Specifically, the EMₗᵢₘᵢₜ at 115° C. drops to 0.5 mA, indicating a 50% degradation in the allowable current capacity. This demonstrates the critical influence of temperature variations ΔT_{AR/OD} on the EM performance, highlighting the importance of accurately accounting for temperature effects in thermal-aware EM analysis methodologies.

To help reduce or eliminate EM-induced failures, the design rules associated with the manufacturing process will include EM rules to limit the average current density through a conductive line and to take into consideration the temperature of the conductive lines during the anticipated operation of the semiconductor device. Integrated circuit designs that pass all of the applicable EM rules are approved for EM signoff and tape-out.

In advanced FinFET processes, the SHE will increase the temperature of the transistor structure by a particular amount ΔT. At least a portion of the SHE that produces the ΔT will, in turn, be transferred to the conductive lines through direct contact with the transistor and via conduction through intervening materials, e.g., ILD materials/layers. In addition to the SHE associated with the FinFET structure, in some embodiments other high-resistance elements (Hi-R) present on the semiconductor device will also contribute to heating the conductive lines.

EM evaluation methodologies which do not identify and compensate for the increased operating temperature of the conductive lines resulting from or induced by thermal coupling to SHE elements within the semiconductor device have an increased risk of underestimating the conductive line operating temperature. Underestimating the conductive line operating temperature will, in turn, produce an EM evaluation result that is overly optimistic, will tend to overestimate the average lifetime of semiconductor devices manufactured to that design, and result in premature field failures of the affected semiconductor devices.

In order to improve EM evaluation methodologies, the EM evaluation should identify and consider those portions of an integrated circuit design in which SHE is expected to increase the operating temperature of at least a portion of a conductive line.

In some embodiments, a thermal aware EM evaluation methodology will include using equation-based device temperature calculations; using a pesudo-3D thermal model for estimating the device-to-metal thermal coupling range(s) and effect(s) and generating an adjusted (or nominal) conductive line temperature; and conducting an EM confirmation check at the adjusted metal temperature to compensate for the SHE and improve the accuracy of the EM evaluation.

In some embodiments, in comparison with other EM evaluation methodologies, the temperature derating methodology of SPR VB effect in thermal-aware EM analysis will provide more accurate local temperature calculations inside the integrated circuit design; more accurate thermal-aware EM evaluation results during the design phase; a reduced risk of premature product failure; reduced simulation runtime using equation-based device temperature calculations; and reduced EM emulation runtime using pseudo-3D thermal models rather than full 3-D thermal modeling.

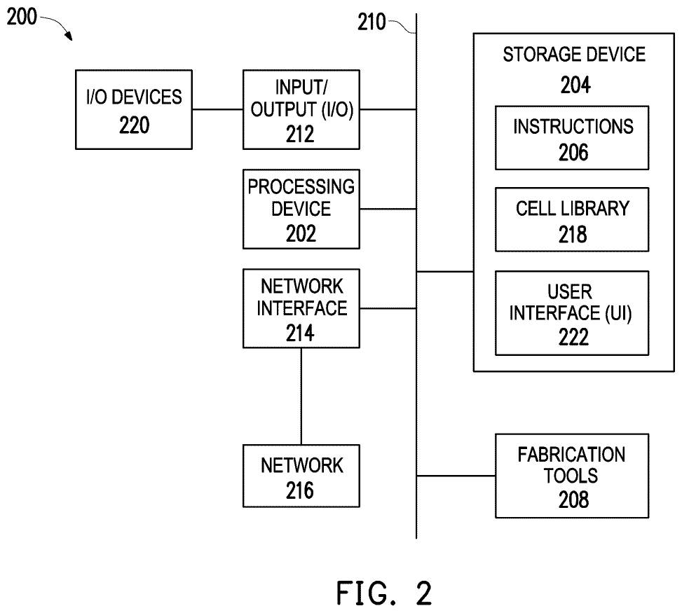

FIG. 2 illustrates an example system that is suitable for evaluating a heat sensitive structure in accordance with some embodiments. The design process may be implemented by a computer system, such as an ECAD system. Some or all of the operations for design (e.g., layout) methods disclosed herein are capable of being performed as part of a design procedure performed in a design house

In some embodiments, the system 200 includes a system for evaluating a heat sensitive structure. In some embodiments, the system 200 includes a processing device 202 and a non-transitory, computer-readable storage medium 204 (“storage device”). The processing device 202 is any suitable processing device or processing devices. Example processing devices include, but are not limited to, a central processing unit, a microprocessor, a distributed processing system, an application specific integrated circuit, a graphics processing unit, a field programmable gate array, or combinations thereof.

The storage device 204 may be encoded with or store, for example, computer program code (e.g., a set of executable instructions 206). Execution of the executable instructions 206 by the processing device 202 represents (at least in part) an ECAD tool that implements a portion or all of, the methods described herein to produce the designs for the structures and the ICs disclosed herein. Further, the fabrication tools 208 may be included for layout and physical implementation of the ICs. In one or more embodiments, the storage device 204 is a non-transitory electronic, magnetic, optical, electromagnetic, infrared, and/or a semiconductor system (or apparatus or device). For example, the storage device 204 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, the storage device 204 includes a compact disk-read only memory (CD-ROM), a compact disk-read/write (CD-R/W), and/or a digital video disc (DVD).

The processing device 202 is operably connected to the storage device 204 via a bus 210. The processing device 202 is also operably connected to an input/output (I/O) interface 212 and a network interface 214 by the bus 210. The network interface 214 is operably connected to a network 216 so that the processing device 202 and the storage device 204 are capable of connecting to external elements via the network 216. In one or more embodiments, the network 216 is illustrative of any type of wired and/or wireless network, such as an intranet and/or a distributed computing network (e.g., the Internet).

The network interface 214 allows the system 200 to communicate with other computing or electronic devices (not shown) via the network 216. The network interface 214 includes wireless network interfaces and/or wired network interfaces. Example wireless network interfaces include BLUETOOTH, WIFI, WIMAX, GPRS, or WCDMA. Example wired network interfaces include ETHERNET, USB, or IEEE-1364. In one or more embodiments, some or all of the processes and/or methods disclosed herein are implemented in a distributed system via the network 216.

The processing device 202 is configured to execute the executable instructions 206 encoded in the storage device 204 to cause the system 200 to be usable for performing some or all of the processes and/or methods described herein. For example, an electronic design application (e.g., in an ECAD system or as a standalone application) can be configured to perform the methods and techniques shown in the following figures. Given the complexity of integrated circuits, and since integrated circuits include thousands, millions, or billions of components, the human mind is unable to perform the methods and techniques depicted in the figures in this disclosure. Unlike the human mind, an electronic design application is able to perform the operations associated with the figures in this disclosure.

In one or more embodiments, the storage device 204 stores the executable instructions 206 configured to cause the system 200 to be usable for performing some or all of the processes and/or methods. In one or more embodiments, the storage device 204 also stores information that facilitates execution of a portion of or all of the processes and/or methods. In one or more embodiments, the storage device 204 stores a cell library 218 that includes (at least in part) standard and/or previously designed cells.

The I/O interface 212 is operably connected to I/O devices 220. In one or more embodiments, the I/O devices 220 include one or more of an image capture device, a microphone, a scanner, a keyboard, a keypad, a mouse, a trackpad, a touchscreen, and/or cursor direction keys for communicating information and commands to the processing device 202. The I/O devices 220 may also include one or more displays, one or more speakers, a printer, headphones, a haptic or tactile feedback device, and the like.

The system 200 is configured to receive information through the I/O interface 212. The information received through the I/O interface 212 includes one or more of instructions, data, design rules, cell libraries, and/or other parameters for processing by the processing device 202. The information is transferred to the processing device 202 via the bus 210. The system 200 is configured to receive information related to a user interface (UI) through the I/O interface 212. The information is stored in the storage device 204 as a UI 222 or for presentation in the UI 222.

In some embodiments, a portion or all of the processes and/or methods is implemented as a standalone software application (e.g., an EDA) for execution by a processing device (e.g., processing device 202). In some embodiments, a portion or all of the processes and/or methods is implemented as a software application that is a part of an additional software application. In some embodiments, a portion or all of the processes and/or methods is implemented as a plug-in to a software application. In some embodiments, at least one of the processes and/or methods is implemented as a software application that is a portion of an EDA tool. In some embodiments, a portion or all of the processes and/or methods is implemented as a software application that is used by the system 200. In some embodiments, a layout diagram which includes standard and/or previously designed cells is generated using a tool such as VIRTUOSO available from CADENCE DESIGN SYSTEMS, Inc., or another suitable layout generating tool.

In some embodiments, the processes are realized as functions of a program stored in a non-transitory computer readable recording medium (e.g., the storage device 204). Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

As noted above, embodiments of the system 200 may include the fabrication tools 208 for implementing the processes and/or methods stored in the storage device 204. For instance, a synthesis may be performed on a design in which the behavior and/or functions desired from the design are transformed to a functionally equivalent logic gate-level circuit description by matching the design to cells selected from the cell library 218. The synthesis results in a functionally equivalent logic gate-level circuit description, such as a gate-level netlist. Based on the gate-level netlist, a photolithographic mask may be generated that is used to fabricate the analog integrated circuit by the fabrication tools 208.

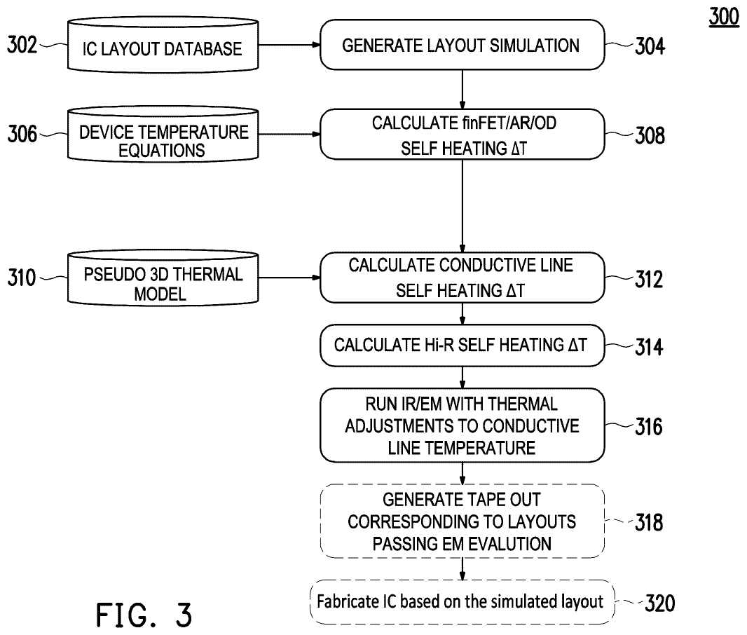

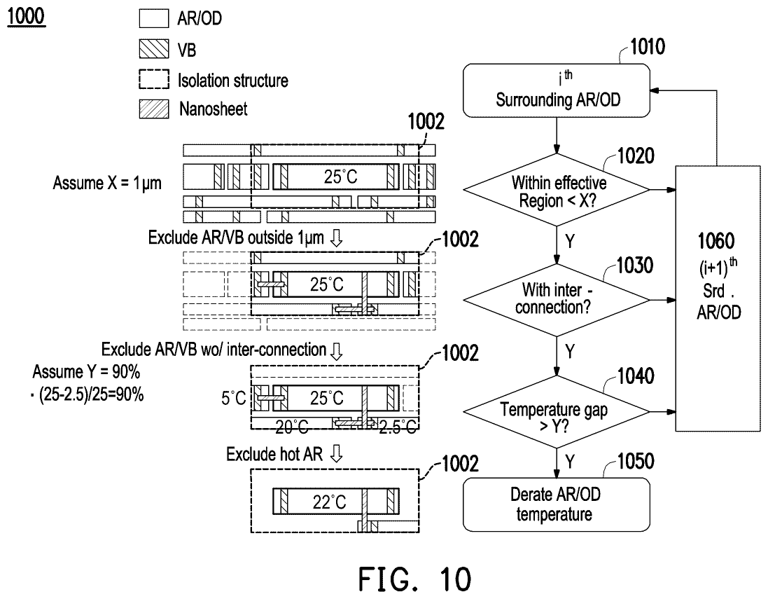

FIG. 3 is a schematic view of an EM tool useful in the operation of a thermal aware EM analysis in accordance with some embodiments. In some embodiments according to FIG. 3, EM tool 300 includes a database 302 or other data storage device for storing design data corresponding to an integrated circuit layout, the design data then being used to generate a simulated design layout 304. The processing device 202 may comprise at least one processor configured to generate a simulated design layout 304. In some embodiments, the processing device 202 may comprise at least one processor configured to calculate an anticipated increase in temperature ΔT. For example, the simulated design layout 304 is then used in combination with device temperature equations retrieved from a memory 306 to calculate 308 an anticipated increase in temperature ΔT for at least a portion of the heat generating devices identified in the simulated design layout, e.g., active region (AR) structures, FinFET, and Hi-R structures. In some embodiments, the active region can be an oxide defined (OD) region in which transistor and other functional semiconductor device elements are formed. In some embodiments, the AR/OD region may include at least one of: a nanosheet device, or a gate-all-around (GAA) transistor. At least one backside via (VB) can be formed on the GAA transistor. The details of step 308 are further described in FIG. 10. After the steps in FIG. 10 are applied, only the AR/OD temperature is updated in step 308 of FIG. 3. Then, in steps 312/314, the updated ΔT_{AR/OD} can be used to evaluate the simulated design layout 304.

In some embodiments, the ΔT for AR/OD structures is calculated using the device temperature equation Eq. 1:

$$Δ T = {R}_{THC} \times finger\_effect \times fin\_effect \times Powe {r}_{perfin * per finger} \qquad [ Eq . 1 ]$$

In some embodiments, the relevant values and/or parameters included in the device temperature equation are provided by the foundry, incorporated in the applicable design rules, or extracted from the integrated circuit layout and include:
R_{THC}: thermal resistance value (typically provided by foundry).
fin number: determined from integrated circuit layout.
finger number: determined from integrated circuit layout power per fin per finger (watt) (typically provided by foundry).
finger-effect-finger number.
fin-effect-fin number.

In some embodiments, the relevant values and/or parameters included in the device temperature equation are provided by the foundry, incorporated in the applicable design rules, or extracted from the integrated circuit layout. In some embodiments, the device temperature can be provided as part of the design tools provided by a semiconductor device foundry including, for example, a Simulation Program with Integrated Circuit Emphasis (SPICE) model corresponding to a particular manufacturing process.

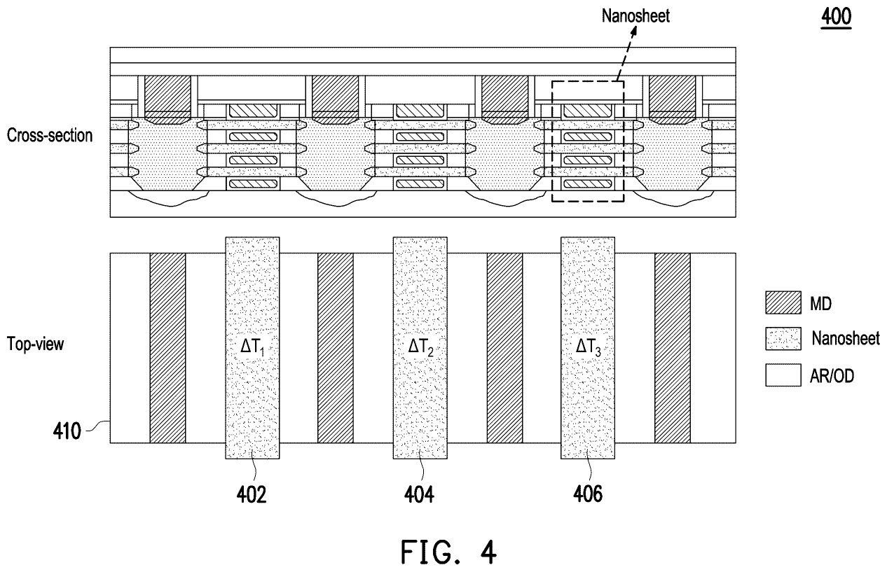

In some embodiments, calculating the ΔT_{AR/OD} for an active region is a function of the individual ΔT calculations for each of the structures incorporated within the particular active region. In some embodiments according to FIG. 4, for example, the ΔT_{AR/OD} for active region active region structure 400 will be a function of ΔT calculations for a first nanosheet 402, a second nanosheet 404, a third nanosheet 406 over active region (AR) structure 410.

In some embodiments, the ΔT for OD structures is calculated using the device temperature equation Eq. 1:

$$Δ {T}_{AR / OD} = s q rt [ \sum ( Δ {T}_{N}^{2} ) / N ] = sqrt [ ( Δ {T}_{1}^{2} + Δ {T}_{2}^{2} + Δ {T}_{3}^{2} ) / 3 ] \qquad [ Eq . 2 ]$$

The temperature offset deviation (ΔT_{AR/OD}) is calculated as the square root of the average of the squared temperature deviations (ΔT_{N}_{²}) across multiple instances. Mathematically, this is expressed as ΔT_{AR/OD}=sqrt[Σ(ΔT_{N}_{²})/N], where N represents the total number of devices on the OD structure. For example, if there are three nanosheet devices on the OD and temperature deviations of each nanosheet device are ΔT₁, ΔT₂, and ΔT₃, the formula simplifies to ΔT_{AR/OD}=sqrt[(ΔT₁_{²}+ΔT₂_{²}+ΔT₃_{²})/3].

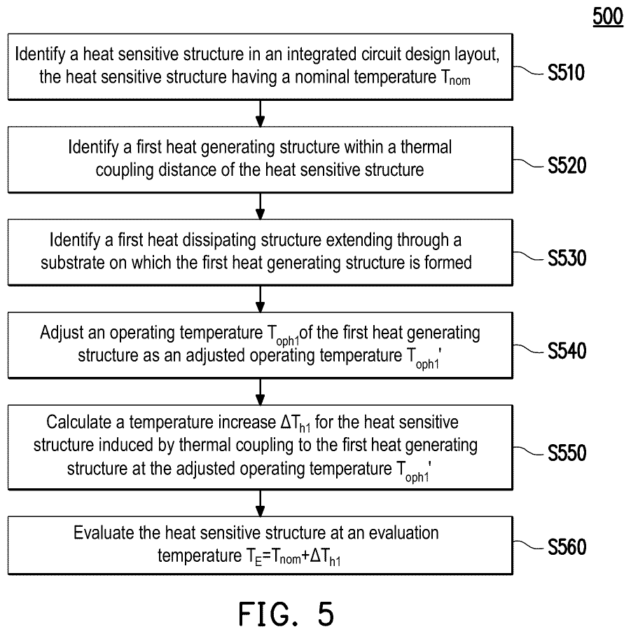

In some embodiments, an operating temperature Tₒₚₕ₁ of a first heat generating structure can be adjusted as an adjusted operating temperature Tₒₚₕ₁′ (as shown in step 540 of FIG. 5). In some embodiments, adjusting an operating temperature Tₒₚₕ₁ of the first heat generating structure may comprise subtracting the operating temperature Tₒₚₕ₁ with a constant value (e.g., ΔT_{AR/OD}=sqrt[(ΔT₁_{²}+ΔT₂_{²}+ΔT₃_{²})/3]−X). In some embodiments, the constant value can be determined as a function of at least one of a process parameter, a current value, a geometric characteristic, or a material property. In some embodiments, the constant value can be constrained by an upper limit. In some embodiments, adjusting an operating temperature Tₒₚₕ₁ of the first heat generating structure may comprise subtracting the operating temperature Tₒₚₕ₁ with a varying value that is a function of a distance away from the first heat dissipating structure (e.g., ΔT_{AR/OD}=rms[ΔT₁−f(d₁), . . . , ΔT_{N}−f(d_{N})]).

In some embodiments, this cumulative ΔT_{AR/OD} will then be used in subsequent calculations for evaluating the magnitude of thermal coupling between this active region and proximate heat sensitive structures, e.g., conductive lines.

Using a pseudo-3-D thermal model retrieved from memory 310, the EM tool 300 then calculates the anticipated increase in temperature ΔT for both conductive lines 312 and Hi-R structures 314 identified in the integrated circuit layout as a result of self-heating. The EM tool 300 then uses the ΔT data for the heat sensitive structures and proximate heat generating structures to calculate an adjusted operating temperature T_{E} for the temperature sensitive structures, e.g., conductive lines, during operation of a semiconductor device according to the integrated circuit layout.

In some embodiments, the pseudo-3-D thermal model will incorporate a number of coefficients, e.g., a, b, c, d, that will be specific to each of the materials and/or layers incorporated in the integrated circuit design under analysis and to the particular manufacturing process that will be used to produce semiconductor devices according to the integrated circuit design. In some embodiments, the ΔT for a heat sensitive structure, e.g., a conductive line, will be a function of both self-heating of the heat sensitive structure and the thermal contribution(s) from other heat generating structures proximate the heat sensitive structure. In some embodiments, the ΔT for a conductive line, for example, will be calculated according to Eq. 3 provided below:

$$Δ {T}_{Con} = Δ {T}_{r m s} + f ( a , b , Δ T ch , c , d , Δ T Hi - R , Δ T other\_devices , … ) \qquad [ Eq . 3 ]$$

In some embodiments, the relevant values and/or parameters included in the ΔT_{Con} equation are provided by the foundry, incorporated in the applicable design rules, or extracted from the integrated circuit layout and include:
ΔTᵣₘₛ: current-induced metal heating.
ΔT_{ch}: FinFET device self-heating.
ΔT_{Hi-R}: Hi-R device self-heating.
ΔT_{other_devices}: Device self-heating from other devices.

For the purposes of the ΔT_{Con} calculation according to Eq. 3, other devices will include, for example, bipolar junction transistors (BJT), diodes, and resistors that are thermally coupled to the conductive line under analysis.

The thermal coefficients a, b, c, and d are provided for each layer and/or material and reflect:
a=a derating coefficient (or de-rating coefficient) value reflecting operation at less than maximum capacity
b=a function of ΔTᵣₘₛ and ΔT_{ch} [f(ΔTᵣₘₛ, ΔT_{ch})]
c=a layer effect associated with the layer/material
d=a temperature profile associated with the layer/material

In step 312, the processing device 202 may comprise at least one processor configured to calculate conductive line self-heating ΔT. Considering the presence of interconnections, such as MO or BMO layers, in the nanosheet active region can be identified. AR/OD regions without interconnections can be excluded from further analysis. The EM tool then performs an electromigration (EM) analysis using the adjusted temperature for heat-sensitive structures, such as interconnection lines, to provide a more accurate assessment of the anticipated performance of the semiconductor device. In some embodiments, step 312 (to calculate ΔT_{Con}) can be correlated to steps 1020, 1030, 1040 in FIG. 10. In some embodiments, proximate structures (surrounding or adjacent) within a defined effective region (e.g., within X μm) of the nanosheet active region are identified. The effective region/area is projected to form an impact volume. Any structure that falls within this volume is considered “proximate” and is evaluated to determine whether it acts as a heat-generating structure or a heat sink relative to the nanosheet active region. In some embodiments, the presence of interconnections (e.g., MO or BMO layers) within the nanosheet active region is identified. Regions without interconnections may be excluded from further analysis. An electromigration (EM) tool then performs an EM analysis using an adjusted temperature for heat-sensitive structures, allowing for a more accurate assessment of the device's anticipated performance. Then, a temperature difference between the estimated operating temperature of the nanosheet active region and a proximate structure is calculated. If this difference exceeds a predetermined threshold, that proximate structure is classified as either a heat-generating structure or a heat sink. A significant temperature gap (exceeding, for instance, Y %) also helps validate the effectiveness of the VB (e.g., via temperature-based analysis).

In step 314, the processing device 202 may comprise at least one processor configured to calculate Hi-R self-heating ΔT. The temperature difference between the estimated operating temperature of nanosheet active region and a proximate structure is identified. In some embodiments, the temperature difference between the estimated operating temperature of nanosheet active region and a proximate structure must exceed a predetermined temperature difference before the proximate structure will be identified as a heat generating structure or a heat sink element. A significant temperature gap, exceeding a threshold (e.g., Y %), is used to further validate the effectiveness of the VB. In some embodiments, step 314 can be correlated to steps 1020, 1030, 1040 in FIG. 10. In some embodiments, proximate structures (surrounding or adjacent) within a defined effective region (e.g., within X μm) of the nanosheet active region are identified. The effective region/area is projected to form an impact volume. Any structure that falls within this volume is considered “proximate” and is evaluated to determine whether it acts as a heat-generating structure or a heat sink relative to the nanosheet active region. An electromigration (EM) tool then performs an EM analysis using an adjusted temperature for heat-sensitive structures, allowing for a more accurate assessment of the device's anticipated performance. Then, a temperature difference between the estimated operating temperature of the nanosheet active region and a proximate structure is calculated. If this difference exceeds a predetermined threshold, that proximate structure is classified as either a heat-generating structure or a heat sink. A significant temperature gap (exceeding, for instance, Y %) also helps validate the effectiveness of the VB (e.g., via temperature-based analysis).

EM tool 300 then runs an EM analysis 316 using the adjusted T_{E} for the heat sensitive structures, e.g., conductive lines, to provide a more accurate analysis of the anticipated performance of the semiconductor device. In some embodiments, the EM tool will generate a tape out data file 318 corresponding to an integrated circuit layout that passes the EM analysis. In some embodiments, the heat sensitive structure is evaluated at an evaluation temperature T_{E}=Tₙₒₘ+ΔTₕ₁ (as shown in step 560 of FIG. 5).

In step 320, an integrated circuit (IC) structure is fabricated based on the simulated design layout 304, which has passed the EM analysis. In some embodiments, the IC fabrication process can rely on ensuring that the design layout has already been validated through electromagnetic (EM) analysis. In this case, the simulated design layout 304 is first subjected to a series of tests (e.g., steps 308, 312, 314, 316, and/or 318) that confirm its compliance with EM performance criteria. This step ensures that any significant issues, such as electromagnetic interference or signal integrity concerns, have been addressed prior to committing resources to the physical construction of the integrated circuit. The result is a more robust and reliable final product, as potential design flaws are caught and corrected in the simulation phase instead of surfacing after fabrication, when remedial actions would be more costly and time-consuming.

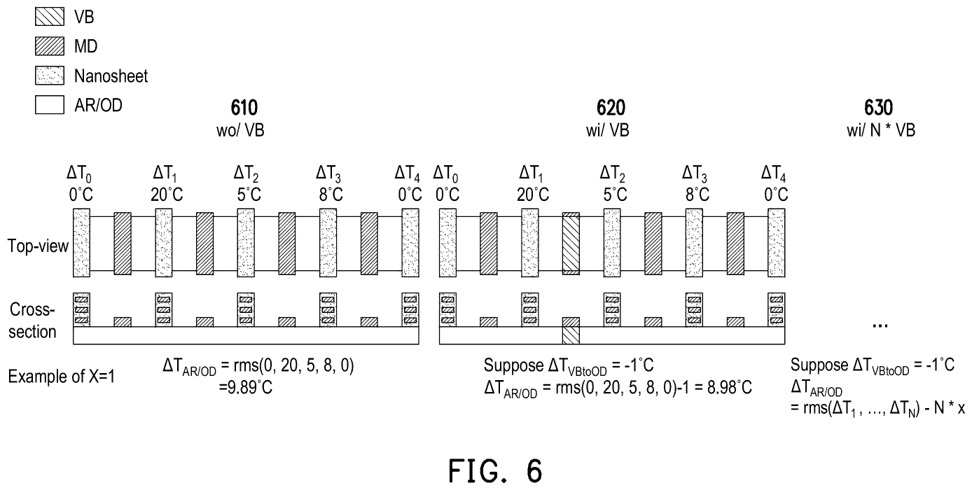

FIG. 5 is a flow chart of a method for evaluating a heat sensitive structure in accordance with some embodiments. FIGS. 6-10 collectively provide an example integrated circuit being evaluated through the method 500, and thus, the following discussion of the method 500 will be provided in conjunction with FIGS. 6-10. It should be noted that the method 500 is merely an example and is not intended to limit the present disclosure. Accordingly, it is understood that additional operations may be provided before, during, and after the method 500 of FIG. 5, and that some other operations may only be briefly described herein.

In various embodiments, the method 500 may start at operation 510 in which a schematic of an integrated circuit is received by the evaluating system 300. The method 500 comprises identifying a heat sensitive structure in an integrated circuit design layout. The heat sensitive structure may have a nominal temperature Tₙₒₘ. In some embodiments, the heat sensitive structure comprises a conductive line. In some embodiments, an AR/OD temperature can be obtained first. The updated ΔT_{AR/OD} can be used to evaluate ΔT for the conductive line.

Next, the method 500 may proceed to operation 520 in which a first heat generating structure can be identified. The first heat generating structure can be within a thermal coupling distance of the heat sensitive structure. In some embodiments, the first heat generating structure includes a transistor structure that includes at least one of: a number of gate structures, a number of stacks of nanostructures, or a number of source/drain structures. In some embodiments, the heat generating structure includes a number of heat generating elements. An operating temperature Tₒₑ of each of the heat generating elements can be calculated.

Next, the method 500 may proceed to operation 530 in which a first heat dissipating structure can be identified. The first heat dissipating structure can be extending through a substrate on which the first heat generating structure is formed.

Next, the method 500 may proceed to operation 540 in which an operating temperature Tₒₚₕ₁ of the first heat generating structure can be adjusted as an adjusted operating temperature Tₒₚₕ₁′. In some embodiments, the step of adjusting an operating temperature Tₒₚₕ₁ of the first heat generating structure may comprise subtracting the operating temperature Tₒₚₕ₁ with a constant value. In some embodiments, the constant value can be determined as a function of at least one of a process parameter, a current value, a geometric characteristic, or a material property. In some embodiments, the constant value can be constrained by an upper limit. In some embodiments, the step of adjusting an operating temperature Tₒₚₕ₁ of the first heat generating structure may comprise subtracting the operating temperature Tₒₚₕ₁ with a varying value that is a function of a distance away from the first heat dissipating structure.

In some embodiments, the method 500 may further comprise identifying a second heat generating structure within the thermal coupling distance of the heat sensitive structure. The method 500 may further comprise determining that the second heat generating structure is located within an impact range of the first heat generating structure. The method 500 may further comprise determining that the first heat generating structure and the second heat generating structure are coupled to each other with an interconnection structure. The method 500 may further comprise determining that a difference between the operating temperature Tₒₚₕ₁ of the first heat generating structure and an operating temperature Tₒₚₕ₂ of the second heat generating structure exceeds a threshold. The method 500 may further comprise further adjusting the operating temperature T_{oph1′}. In some embodiments, the first heat generating structure and the second heat generating structure can be disposed on a first side of the substrate. The interconnection structure can be disposed on a second side of the substrate. In some embodiments, the first heat generating structure and the second heat generating structure can be separated by an isolation structure.

Next, the method 500 may proceed to operation 550 in which a temperature increase ΔTₕ₁ for the heat sensitive structure is calculated. The temperature increase ΔTₕ₁ is induced by thermal coupling to the first heat generating structure at the adjusted operating temperature Tₒₚₕ₁′.

Next, the method 500 may proceed to operation 560 in which the heat sensitive structure is evaluated at an evaluation temperature T_{E}=Tₙₒₘ+ΔTₕ₁. In some embodiments, the step of evaluating the heat sensitive structure comprises performing an electromigration analysis on the conductive line.

The present disclosure introduces several methodologies to account for the backside via (VB) effect in calculating active region (AR) temperature, ensuring accurate thermal-aware electromigration (EM) analysis. The methods include: (1) treating the VB effect as a constant term, ΔT_{VBtoOD}, applied directly to the AR/OD; (2) modeling the VB effect as a constant term, ΔT_{VBtoNS}, specifically impacting the nanosheet; (3) representing the VB effect as a gradient term, ΔT_{VBtoNS,G}, to capture its impact on the nanosheet with spatial variation; (4) incorporating the VB effect as an interactive term with isolation structures in the process; and (5) implementing a context-aware methodology that considers the VB effect within the AR/OD cluster. These approaches provide a comprehensive framework for integrating VB effects into thermal and EM analyses across various design and process contexts.

FIG. 6 is a plan view of an active region (AR) with and without backside via (VB) effect in accordance with some embodiments. The first methodology models the backside via (VB) effect as a constant term, ΔT_{VBtoOD}, applied to the OD temperature. To derive this, SPICE simulations are run to obtain the temperature deviations of nanosheet devices, such as ΔT₀₋₄. The VB effect introduces a constant heat derating impact across the entire OD, represented as ΔT_{VBtoOD}=−X° C. per VB. This value, ΔT_{VBtoOD}, is determined using TCAD simulations that consider factors such as material properties, geometric dimensions (length, width, thickness), and/or boundary conditions. The constant X can be a function of various parameters, including process characteristics, current, geometry, and material composition. If multiple VBs are present within the AR/OD region, their effects can be summed directly, while maintaining an upper limit to clamp the temperature derating. For example, as shown in FIG. 6, for an AR/OD region without VB 610, using the root-mean-square (RMS) calculation of ΔT_{AR/OD}=rms(0, 20, 5, 8, 0), the resulting temperature deviation is 9.89° C.

For an AR/OD region with a VB 620, suppose the VB effect on OD temperature is characterized by a constant term, ΔT_{VBtoOD}=−1° C. This derating value influences the overall temperature deviation in the AR/OD region. By applying the root-mean-square (RMS) formula to the temperature deviations (0, 20, 5, 8, 0) and incorporating the VB effect, the adjusted temperature deviation is calculated as ΔT_{AR/OD}=rms(0, 20, 5, 8, 0)−1, resulting in ΔT_{AR/OD}=8.98° C. This demonstrates how the VB effect can effectively lower the calculated temperature deviation, improving thermal management in the AR/OD region.

For an AR/OD region with N number of VBs 630, suppose the VB effect on the OD temperature is represented by a constant derating term, ΔT_{VBtoOD}=−1° C. The adjusted temperature deviation, ΔT_{AR/OD}, can be calculated using the formula ΔT_{AR/OD}=rms(ΔT₁, . . . , ΔT_{N})−N*X, where rms(ΔT₁, . . . , ΔT_{N}) represents the root-mean-square of the temperature deviations across N data points, and N*X accounts for the cumulative effect of N backside vias (VBs), with each contributing a derating factor X (e.g., ΔT_{VBtoOD}). This corresponds to the step 540 of an operating temperature Tₒₚₕ₁ in FIG. 5. In some embodiments, an operating temperature Tₒₚₕ₁ of the first heat generating structure can be adjusted as an adjusted operating temperature Tₒₚₕ₁′. In some embodiments, the step of adjusting an operating temperature Tₒₚₕ₁ of the first heat generating structure may comprise subtracting the operating temperature Tₒₚₕ₁ with a constant value (e.g., X).

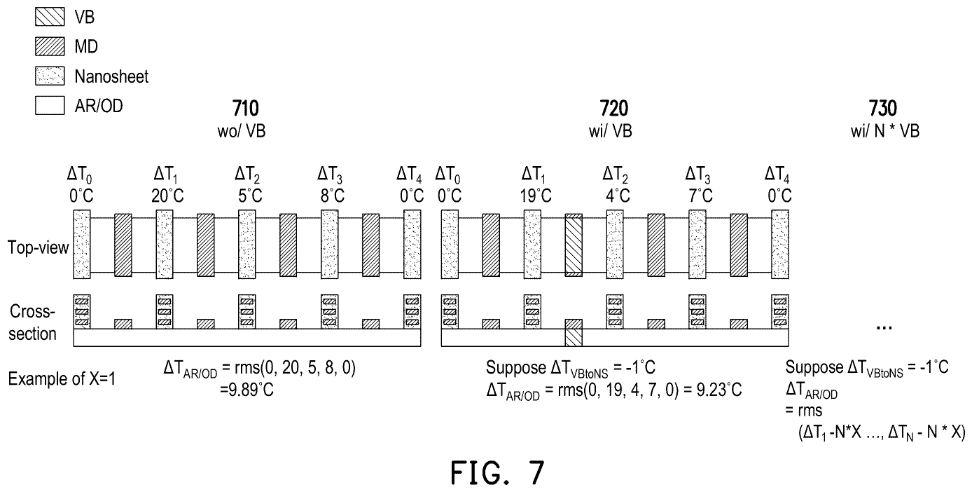

FIG. 7 is a plan view of an active region (AR) with and without backside via (VB) effect in accordance with some embodiments. The second methodology models the backside via (VB) effect as a constant term, ΔT_{VBtoNS}, specifically applied to nanosheet devices. To determine this effect, SPICE simulations are conducted to measure the temperature deviations of nanosheet devices, such as ΔT₀₋₄. The VB effect introduces a consistent heat derating impact on nanosheet devices, represented as ΔT_{VBtoNS}=−X° C. per VB. This constant value, ΔT_{VBtoNS}, is derived through TCAD simulations, which account for material properties, geometric factors (length, width, thickness), and boundary conditions. The derating factor X depends on various parameters, including the manufacturing process, current flow, device geometry, and material properties. When multiple VBs exist within the AR/OD region, their effects can be aggregated directly. To ensure stability, an upper limit is applied to clamp the total temperature derating. For example, as shown in FIG. 7, for an AR/OD region without VB 710, using the root-mean-square (RMS) calculation of ΔT_{AR/OD}=rms(0, 20, 5, 8, 0), the resulting temperature deviation is 9.89° C.

For an AR/OD region with a VB 720, suppose the backside via (VB) effect on nanosheet devices is represented by a constant temperature derating term, ΔT_{VBtoNS}=−1° C. Using the root-mean-square (RMS) method to calculate the temperature deviation across nanosheet devices, the RMS value of the given temperature deviations (0, 19, 4, 7, 0) is computed as ΔT_{AR/OD}=rms(0, 19, 4, 7, 0), resulting in ΔT_{AR/OD}=9.23° C. This calculation demonstrates how the VB effect influences the overall thermal performance of nanosheet devices, offering a precise approach to incorporate temperature derating into thermal-aware electromigration (EM) analysis.

For an AR/OD region with N number of VBs 730, suppose the VB effect on nanosheet devices introduces a constant derating term, ΔT_{VBtoNS}=−1° C. The overall temperature deviation, ΔT_{AR/OD}, can be calculated using the root-mean-square (RMS) method while accounting for the cumulative effect of N VBs. The formula is expressed as ΔT_{AR/OD}=rms(ΔT₁−N*X, . . . , ΔT_{N} N*X), where ΔT₁ to ΔT_{N} represent the individual temperature deviations, and N*X accounts for the cumulative derating impact from N VBs. This approach provides a systematic way to incorporate the VB effect into the thermal analysis of nanosheet devices, ensuring precise modeling of temperature deviations and enhancing the reliability of thermal-aware electromigration (EM) analysis. This corresponds to the step 540 of an operating temperature Tₒₚₕ₁ in FIG. 5. In some embodiments, an operating temperature Tₒₚₕ₁ of the first heat generating structure can be adjusted as an adjusted operating temperature Tₒₚₕ₁′. In some embodiments, the step of adjusting an operating temperature Tₒₚₕ₁ of the first heat generating structure may comprise subtracting the operating temperature Tₒₚₕ₁ with a constant value (e.g., X).

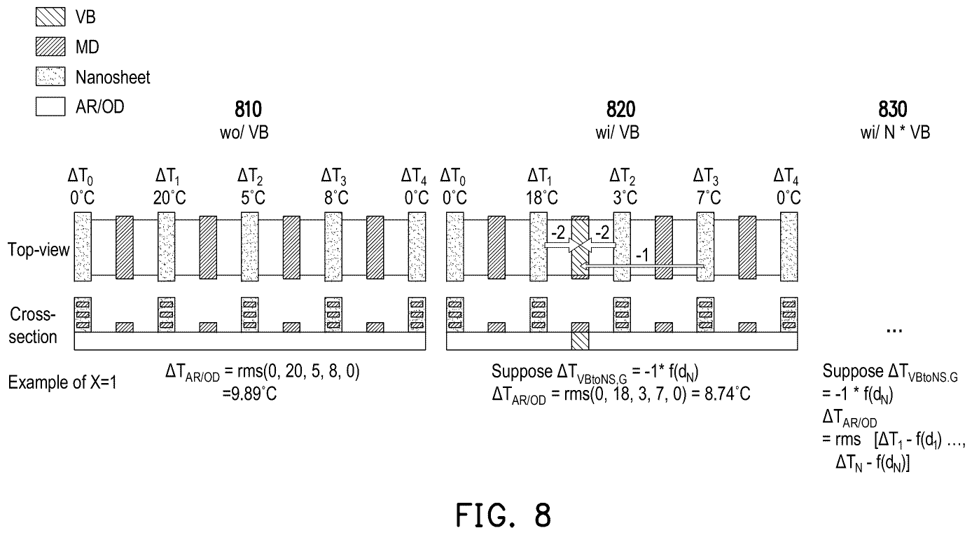

FIG. 8 is a plan view of an active region (AR) with and without backside via (VB) effect in accordance with some embodiments. The third methodology models the backside via (VB) effect as a gradient term, ΔT_{VBtoNS,G}, applied to nanosheet devices. This approach considers the distance-dependent impact of the VB effect on heat derating. Using SPICE simulations, the temperature deviations of nanosheet devices (e.g., ΔT₀₋₄) are determined. The VB effect introduces a gradient heat derating term expressed as ΔT_{VBtoNS,G}=−X*f(d)° C. per VB, where f(d) is a gradient function that varies with the distance from the device. TCAD simulations are then employed to calculate ΔT_{VBtoNS,G}, incorporating factors such as material properties, geometric parameters (length, width, thickness), and boundary conditions. The derating factor X is a function of process parameters, current, geometry, material properties, and other influencing variables. When multiple VBs exist in the AR/OD region, their effects can be aggregated directly. To ensure stability and avoid excessive derating, an upper limit is applied to clamp the total temperature derating. For example, as shown in FIG. 8, for an AR/OD region without VB 810, using the root-mean-square (RMS) calculation of ΔT_{AR/OD}=rms(0, 20, 5, 8, 0), the resulting temperature deviation is 9.89° C.

For an AR/OD region with a VB 820, suppose the VB effect on nanosheet devices is represented as a gradient term, ΔT_{VBtoNS,G}=−1*f(d_{N}), where f(d_{N}) is a distance-dependent function capturing the spatial variation of the heat derating effect. The overall temperature deviation, ΔT_{AR/OD}, is calculated using the root-mean-square (RMS) method for the given temperature deviations (0, 18, 3, 7, 0). The result is ΔT_{AR/OD}=rms(0, 18, 3, 7, 0)=8.74° C. This calculation highlights the distance-dependent impact of the VB effect, demonstrating its influence on thermal performance and its importance in nanosheet-level thermal-aware electromigration (EM) analysis.

For an AR/OD region with N number of VBs 830, suppose the VB effect on nanosheet devices is modeled as a gradient term, ΔT_{VBtoNS,G}=−1*f(d_{N}), where f(d_{N}) represents a distance-dependent function accounting for the spatial variation of the heat derating effect. The total temperature deviation, ΔT_{AR/OD}, is calculated using the root-mean-square (RMS) method, considering the adjusted temperature deviations for each device. The formula is expressed as ΔT_{AR/OD}=rms[ΔT₁−f(d₁), . . . , ΔT_{N}−f(d_{N})], where ΔT₁ through ΔT_{N} are the initial temperature deviations, and f(d₁) through f(d_{N}) apply the gradient derating effects based on the distance from each nanosheet device. This formulation captures the non-uniform thermal impacts of VB induced heat dissipation, providing a robust framework for nanosheet-level thermal-aware electromigration (EM) analysis. This corresponds to the step 540 of an operating temperature Tₒₚₕ₁ in FIG. 5. In some embodiments, an operating temperature Tₒₚₕ₁ of the first heat generating structure can be adjusted as an adjusted operating temperature Tₒₚₕ₁′. In some embodiments, the step of adjusting an operating temperature Tₒₚₕ₁ of the first heat generating structure may comprise subtracting the operating temperature Tₒₚₕ₁ with a varying value that is a function of a distance away from the first heat dissipating structure (e.g., f(d_{N})).

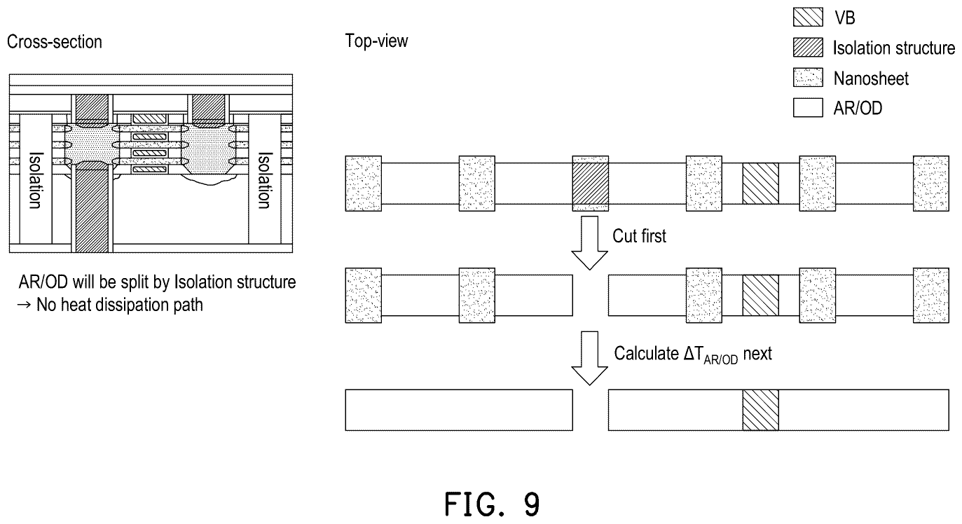

FIG. 9 is a plan view of an active region (AR) with and without backside via (VB) effect in accordance with some embodiments. The fourth methodology considers the interactive effect of backside vias (VB) with isolation structures present in the process. When an isolation structure or similar cutting layers are applied to the overdrive (OD) region, the OD is effectively split into isolated sections. This segmentation disrupts the heat dissipation path, significantly altering the thermal profile of the OD. In such scenarios, the VB effect can be explicitly incorporated into the ΔT_{AR/OD} calculation to account for the restricted thermal flow. By considering the interaction between VB and isolation structures, this method ensures accurate modeling of temperature deviations and their impact on nanosheet devices, providing a more comprehensive thermal-aware electromigration (EM) analysis.

FIG. 10 is a flow chart of a method for evaluating a heat sensitive structure in accordance with some embodiments. The fifth methodology introduces a context-aware approach to model the VB effect within an overdrive (OD) cluster. This method defines effective VBs based on specific contextual parameters. In some embodiments, FIG. 10 shows the details of step 308. After the steps in FIG. 10 are applied, the AR/OD temperature is updated in step 308 of FIG. 3. Then, in steps 312/314, the updated ΔT_{AR/OD} can be used to evaluate the simulated design layout 304.

In embodiments of methods according to FIG. 10, in operation 1010, a heat sensitive structure in an integrated circuit design layout is identified. The heat sensitive structure may have a nominal temperature Tₙₒₘ. In some embodiments, one or more active region (AR) structures and other structures for which an increased operating temperature will degrade performance and/or lifetime, are identified during a structural and/or operational review of an integrated circuit design layout that is under evaluation.

In operation 1020, structures proximate, e.g., surrounding and/or adjacent, within effective region/area (e.g., <X μm) 1002 are identified. In some embodiments, VBs are considered effective if the VBs fall within a predefined range, such as X μm (e.g., X=1 μm), from the nanosheet devices. The effective region/area 1002 is defined as a horizontal region within the impact range of a periphery of the nanosheet active region. This effective region/area is projected vertically, or rotated about a longitudinal axis of the nanosheet active region 1002, to define an impact volume. The surrounding structures that fall within, or at least partially within, this impact volume have the potential to affect the nanosheet active region 1002 and are referred to as proximate structures. In some embodiments, each of these proximate structures are then, in turn, evaluated for identification as a heat generating structure or a heat sink element relative to the nanosheet active region 1002.

In operation 1030, the presence of interconnections, such as MO or BMO layers, in the nanosheet active region 1002 is identified. AR/OD regions without interconnections can be excluded from further analysis. The EM tool then performs an electromigration (EM) analysis using the adjusted temperature for heat-sensitive structures, such as interconnection lines, to provide a more accurate assessment of the anticipated performance of the semiconductor device.

In operation 1040, the temperature difference between the estimated operating temperature of nanosheet active region 1002 and a proximate structure is identified. In some embodiments, the temperature difference between the estimated operating temperature of nanosheet active region 1002 and a proximate structure must exceed a predetermined temperature difference before the proximate structure will be identified as a heat generating structure or a heat sink element. A significant temperature gap, exceeding a threshold (e.g., Y %), is used to further validate the effectiveness of the VB.

Operation 1060 involves a query regarding the extent to which the temperature sensitive structures within the integrated circuit design have been successfully evaluated for potential identification as a heat generating structure. If fewer than all of the temperature sensitive structures on the integrated circuit design have been identified, method 1000 operation branches from operation 1020 to operation 1060, from operation 1030 to operation 1060, and from operation 1040 to operation 1060.

In operation 1050, the evaluated temperature T_{E}, which takes into account heating effects, or the fully adjusted temperature, which takes into account both heating and cooling effects with regard to the nanosheet active region 1002 is used in running an EM evaluation to determine whether or not the integrated circuit design layout under evaluation satisfies the lifetime and performance goals for the particular design. By incorporating these contextual factors, this methodology provides a refined and practical framework to evaluate VB impacts, enabling precise thermal-aware electromigration (EM) analysis tailored to clustered AR/OD regions.

The present disclosure enhances the accuracy of active region (AR) temperature calculations in super power rail (SPR) designs, ensuring a more precise assessment of thermal effects. By providing a more reliable thermal-aware electromigration (EM) check, the methodology improves the predictive capability of EM analysis, minimizing uncertainties in SPR design processes. Consequently, the risk of product failure due to thermal or EM-related issues becomes manageable, leading to increased reliability and robustness in semiconductor device performance.

The present disclosure provides various embodiments of a method for evaluating a heat sensitive structure. The method comprises identifying a heat sensitive structure in an integrated circuit design layout, the heat sensitive structure having a nominal temperature Tₙₒₘ. The method comprises identifying a first heat generating structure within a thermal coupling distance of the heat sensitive structure. The method comprises identifying a first heat dissipating structure extending through a substrate on which the first heat generating structure is formed. The method comprises adjusting an operating temperature Tₒₚₕ₁ of the first heat generating structure as an adjusted operating temperature Tₒₚₕ₁′. The method comprises calculating a temperature increase ΔTₕ₁ for the heat sensitive structure induced by thermal coupling to the first heat generating structure at the adjusted operating temperature Tₒₚₕ₁′. The method comprises evaluating the heat sensitive structure at an evaluation temperature T_{E}−Tₙₒₘ+ΔTₕ₁. This disclosure relates to a methodology for modeling the backside via (VB) effect in thermal-aware EM analysis.

The present disclosure provides various embodiments of a method for evaluating a heat sensitive structure. The method comprises identifying a heat sensitive structure in an integrated circuit design layout, the heat sensitive structure having a nominal temperature Tₙₒₘ. The method comprises identifying a heat generating structure within a thermal coupling distance of the heat sensitive structure. The heat generating structure includes a number of heat generating elements. The method comprises calculating an operating temperature Tₒₑ of each of the heat generating elements. The method comprises calculating an operating temperature Tₒₚₕ of the heat generating structure based on the operating temperature Tₒₑ of each of the heat generating elements. The method comprises identifying a number of heat dissipating structures each extending through a substrate on which the heat generating structure is formed. In response to identifying the number of heat dissipating structures, the method comprises adjusting the operating temperature Tₒₚₕ as an adjusted operating temperature Tₒₚₕ′. The method comprises calculating a temperature increase ΔTₕ₁ for the heat sensitive structure induced by thermal coupling to the heat generating structure at the adjusted operating temperature Tₒₚₕ′. The method comprises evaluating the heat sensitive structure at an evaluation temperature T_{E}=Tₙₒₘ+ΔTₕ.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for evaluating a heat sensitive structure comprising:
identifying a heat sensitive structure in an integrated circuit design layout, the heat sensitive structure having a nominal temperature Tₙₒₘ;
identifying a first heat generating structure within a thermal coupling distance of the heat sensitive structure;
identifying a first heat dissipating structure extending through a substrate on which the first heat generating structure is formed;
adjusting an operating temperature Tₒₚₕ₁ of the first heat generating structure as an adjusted operating temperature Tₒₚₕ₁′;
calculating a temperature increase ΔTₕ₁ for the heat sensitive structure induced by thermal coupling to the first heat generating structure at the adjusted operating temperature Tₒₚₕ₁′; and
evaluating the heat sensitive structure at an evaluation temperature T_{E}=Tₙₒₘ+ΔTₕ₁.

2. The method of claim 1, wherein the heat sensitive structure comprises a conductive line.

3. The method of claim 2, wherein the step of evaluating the heat sensitive structure comprises performing an electromigration analysis on the conductive line.

4. The method of claim 1, wherein the first heat generating structure includes a transistor structure that includes at least one of: a number of gate structures, a number of stacks of nanostructures, or a number of source/drain structures.

5. The method of claim 1, wherein the step of adjusting an operating temperature Tₒₚₕ₁ of the first heat generating structure comprise subtracting the operating temperature Tₒₚₕ₁ with a constant value.

6. The method of claim 1, the step of adjusting an operating temperature Tₒₚₕ₁ of the first heat generating structure comprise subtracting the operating temperature Tₒₚₕ₁ with a varying value that is a function of a distance away from the first heat dissipating structure.

7. The method of claim 1, further comprising:
identifying a second heat generating structure within the thermal coupling distance of the heat sensitive structure;
determining that the second heat generating structure is located within an impact range of the first heat generating structure;
determining that the first heat generating structure and the second heat generating structure are coupled to each other with an interconnection structure; and
determining that a difference between the operating temperature Tₒₚₕ₁ of the first heat generating structure and an operating temperature Tₒₚₕ₂ of the second heat generating structure exceeds a threshold; and
further adjusting the operating temperature Tₒₚₕ₁′.

8. The method of claim 7, wherein the first heat generating structure and the second heat generating structure are disposed on a first side of the substrate, and the interconnection structure is disposed on a second side of the substrate.

9. The method of claim 7, wherein the first heat generating structure and the second heat generating structure are separated by an isolation structure.

10. A method for evaluating a heat sensitive structure comprising:
identifying a heat sensitive structure in an integrated circuit design layout, the heat sensitive structure having a nominal temperature Tₙₒₘ;
identifying a heat generating structure within a thermal coupling distance of the heat sensitive structure, wherein the heat generating structure includes a number of heat generating elements;
calculating an operating temperature Tₒₑ of each of the heat generating elements;
calculating an operating temperature Tₒₚₕ of the heat generating structure based on the operating temperature Tₒₑ of each of the heat generating elements;
identifying a number of heat dissipating structures each extending through a substrate on which the heat generating structure is formed;
in response to identifying the number of heat dissipating structures, adjusting the operating temperature Tₒₚₕ as an adjusted operating temperature Tₒₚₕ′;
calculating a temperature increase ΔTₕ₁ for the heat sensitive structure induced by thermal coupling to the heat generating structure at the adjusted operating temperature Tₒₚₕ′; and
evaluating the heat sensitive structure at an evaluation temperature T_{E}=Tₙₒₘ+ΔTₕ.

11. The method of claim 10, wherein the step of calculating an operating temperature Tₒₚₕ comprises calculating a root mean square of the operating temperatures Tₒₑ's of the heat generating elements.

12. The method of claim 10, wherein the heat sensitive structure comprises a conductive line, and wherein the step of evaluating the heat sensitive structure comprises performing an electromigration analysis on the conductive line.

13. The method of claim 10, wherein the step of adjusting an operating temperature Tₒₚₕ₁ of the first heat generating structure comprise subtracting the operating temperature Tₒₚₕ of the heat generating structure with a constant value.

14. The method of claim 10, wherein the step of adjusting an operating temperature Tₒₚₕ of the heat generating structure comprise subtracting the operating temperature Tₒₑ of each of the heat generating elements with a constant value.

15. The method of claim 10, wherein the step of adjusting an operating temperature Tₒₚₕ of the heat generating structure comprise subtracting the operating temperature Tₒₑ of each of the heat generating elements with a varying value that is a function of a distance away from the heat dissipating structure.

16. The method of claim 13, wherein the constant value is determined as a function of at least one of a process parameter, a current value, a geometric characteristic, or a material property.

17. The method of claim 13, wherein the constant value is constrained by an upper limit.

18. A system, comprising:
a memory having computer-readable instructions stored thereon; and
a processor that executes the computer-readable instructions to:
identify a heat sensitive structure in an integrated circuit design layout, the heat sensitive structure having a nominal temperature Tₙₒₘ;
identify a heat generating structure within a thermal coupling distance of the heat sensitive structure, wherein the heat generating structure includes a number of heat generating elements;
calculate an operating temperature Tₒₑ of each of the heat generating elements;
calculate an operating temperature Tₒₚₕ of the heat generating structure based on the operating temperature Tₒₑ of each of the heat generating elements;
identify a number of heat dissipating structures each extending through a substrate on which the heat generating structure is formed;
in response to identifying the number of heat dissipating structures, adjust the operating temperature Tₒₚₕ as an adjusted operating temperature Tₒₚₕ′;
calculate a temperature increase ΔTₕ₁ for the heat sensitive structure induced by thermal coupling to the heat generating structure at the adjusted operating temperature Tₒₚₕ′; and
evaluate the heat sensitive structure at an evaluation temperature T_{E}=Tₙₒₘ+ΔTₕ.

19. The system of claim 18, comprising:
the processor that executes the computer-readable instructions to:
adjust an operating temperature Tₒₚₕ of the heat generating structure by subtracting the operating temperature Tₒₑ of each of the heat generating elements with a constant value.

20. The system of claim 18, comprising:
the processor that executes the computer-readable instructions to:
adjust an operating temperature Tₒₚₕ of the heat generating structure by subtracting the operating temperature Tₒₑ of each of the heat generating elements with a varying value that is a function of a distance away from the heat dissipating structure.
